(19) United States
(12) Patent Application Publication
(10) Pub. No.: US 2015/0331762 A1
(43) Pub. Date: Nov. 19, 2015

(54) ACTIVE HOST AND BACKUP HOST IN A HOST ARRANGEMENT FOR COMMUNICATING WITH A TERMINAL CONNECTED TO AN IP NETWORK

(71) Applicant: TELEFONAKTIEBOLAGET LM ERICSSON (PUBL), Stockholm (SE)

(72) Inventors: Per Wollbrand, Stockholm (SE); Clarence Ammervik, Älvsjö (SE); Åke Törnkvist, Stockholm (SE)

(21) Appl. No.: 14/654,433

(22) PCT Filed: Dec. 20, 2012
(86) PCT No.: PCT/SE2012/051465

§ 371 Date: Jun. 19, 2015

(51) Int. Cl. G06F 11/20

(52) U.S. Cl. CPC G06F 11/2007; G06F 2201/85

(57) ABSTRACT

A method in a host arrangement for communicating with a terminal connected to an IP communication network. The arrangement comprises at least two hosts, one operating as active host and the remaining at least one host operating as backup host(s). The arrangement is connected to the IP communication network by means of a switch, wherein each host of the arrangement is connected to the switch by means of an individual link, the active host being associated with an IP and a MAC address. The method comprises detecting a link failure between the active host and the switch, or a malfunction of the active host, and determining a backup host to take over. The method comprises associating the IP and the MAC address of the active host to the determined backup host to take over, and triggering a MAC learning process in the switch.

### TECHNICAL FIELD

The present disclosure relates to communication over an IP communication network and in particular to a host arrangement, a first host and respective methods therein for communication with a terminal connected to an IP network.

### BACKGROUND

In an implementation of a high-availability Internet Protocol version 4, IPv4, end system, two or more physical links connect the end system to an Ethernet network. All links are supervised on layer 2, L2, and next-hop routers are supervised on layer 3, L3, over all links. The L3 supervision uses different host IP addresses for different links. Based on the results of the L2 and L3 supervision, one of the links is selected as active and used for transporting IP traffic. If more than one link is available, one of them is selected based on hard coded or configured preferences. When the active link becomes unavailable, the system selects another link to be active, if any is available. At a link switch, the host transmits gratuitous Address Resolution Protocol, ARP, messages to the network in order to update the ARP caches in the Routers.

There are a couple of problems with the implementation described above. One problem is: when implementing a similar solution for IPv6, switch-over is a time consuming activity if solved in the same manner as IPv4, because of the properties of the Neighbour Discovery protocol used in the IPv6 initialization phases. Another problem is that it is hard to use a commercial/open source IP stack, without, after a link switch, having to modify the MAC address of every single Ethernet frame outside the IP stack. This is true both for IPv4 and IPv6. Yet another problem is that all routers do not handle ARP cache updates (e.g. by Gratuitous ARP) in a proper way (fast enough). Routers might also drop or rate limit ARP messages in order to prevent security attacks.

Link aggregation is a general term that covers several methods for combining multiple L2-network connections in parallel, in order to increase throughput and reliability. The IP layer is connected to the aggregated link and not to each of the participating L2-links. There is no support for L3 supervision on passive link or for settable switch back timer. Furthermore, there is no specified support for a high-availability host residing on several hardware, HW, units.

Linux bonding is a variant of link aggregation. The configurable so called aggregation mode determines the handling of the links. If this mode is chosen, only one link is active at each time. The bond's MAC address is visible only on this link. There is no support for L3 supervision on passive link or for settable switch back timer. Furthermore, there is no support for a high-availability host residing on several HW units.

### SUMMARY

The object is to obviate at least some of the problems outlined above. In particular, it is an object to provide a host arrangement and a method performed thereby, a first host and a method performed thereby, and a virtual host for communicating with a terminal connected to an IP communication network, wherein the host arrangement comprises at least two hosts and any malfunction or link failure associated with an active host of the host arrangement will cause an IP address and a MAC address of that host to be transferred to another host of the host arrangement to take over from the active host. These objects and others may be obtained by providing a host arrangement, a first host and a virtual host, and a method performed by a host arrangement, and performed by a first host according to the independent claims attached below.

According to an aspect a method performed by a host arrangement for communicating with a terminal connected to an IP communication network is provided. The host arrangement comprises at least two hosts, whereof one is operating as active host and the remaining at least one host is operating as backup host(s). The host arrangement is connected to the IP communication network by means of a switch, wherein each host of the host arrangement is connected to the switch by means of an individual link, the active host being associated with an IP address and a MAC address. The method comprises detecting a link failure between the active host and the switch, or a malfunction of the active host; and determining a backup host to take over from the active host. The method further comprises associating the IP address and the MAC address of the active host to the determined backup host to take over from the active host; and triggering a MAC learning process in the switch. In this manner the need for having to update routers in the IP communication network due to the change of hosts is avoided.

According to an aspect, method performed by a first host, operable to be associated with a second host, the hosts being adapted for communicating with a terminal connected to an IP communication network is provided. The first and the second host are connectable to the IP communication network by means of a switch, wherein each host is connectable to the switch by means of an individual link, wherein one of the hosts is operating as active host and the other host is operating as backup host. The method comprises detecting a link failure between the active host and the switch, or a malfunction of the active host; determining a backup host to take over from the active host; and associating the IP address and the MAC address of the active host to the determined backup host to take over.

According to an aspect, a host arrangement adapted for communicating with a terminal connected to an IP communication network is provided. The host arrangement comprises at least two hosts, whereof one is operating as active host and the remaining at least one host is operating as backup host(s). The host arrangement is connected to the IP communication network by means of a switch, wherein each host of the host arrangement is connected to the switch by means of an individual link. The active host is associated with an IP address and a MAC address. The host arrangement comprises a detecting unit adapted to detect a link failure between the active host and the switch, or a malfunction of the active host. The host arrangement further comprises a determining unit adapted to determine a backup host to take over from the active host; and an associating unit adapted to associate the IP address and the MAC address of the active host to the determined backup host to take over. The host arrangement also comprises a triggering unit adapted to trigger a MAC learning process in the switch.

According to an aspect, a virtual host comprising a host arrangement as described above is provided.

According to an aspect, a first host operable to be associated with a second host, the hosts being adapted for communicating with a terminal connected to an IP communication network is provided. The first and the second host are connectable to the IP communication network by means of a switch, wherein each host is connectable to the switch by means of an individual link, wherein one of the hosts is operating as active host and the other host is operating as backup host. The first host comprises a detecting unit adapted to detect a link failure between the active host and the switch, or a malfunction of the active host. The first host further comprises a determining unit adapted to determine a backup host to take over from the active host; and an associating unit adapted to associate the IP address and the MAC address of the active host to the determined backup host to take over.

The host arrangement and the method performed thereby, the first host and the method performed thereby, and the virtual host may have several advantages. One advantage is that there may be no need for having to update routers in the IP communication network due to the change of hosts. This in turn reduces signalling and resource consumption of the routers in the IP communication network. Another advantage may be that robustness and reliability of the host arrangement may be increased since there is at least one host being able to take over from an active host in case of link failure or malfunction of the active host.

### BRIEF DESCRIPTION OF DRAWINGS

Embodiments will now be described in more detail in relation to the accompanying drawings, in which:

FIG. 1 is a flowchart of a method performed by a host arrangement for communicating with a terminal connected to an IP communication network according to an exemplifying embodiment.

FIG. 2 is a flowchart of a method performed by a first host for communicating with a terminal connected to an IP communication network according to an exemplifying embodiment.

FIG. 3a is a schematic overview of a host arrangement connected to an IP communication network via a switch.

FIG. 3b is a block diagram of a host arrangement adapted for communicating with a terminal connected to an IP communication network according to an exemplifying embodiment.

FIG. 4a is a block diagram of a first host adapted for communicating with a terminal connected to an IP communication network according to an exemplifying embodiment.

FIG. 4b is a block diagram of a first host adapted for communicating with a terminal connected to an IP communication network according to yet an exemplifying embodiment.

FIG. 5 is an illustration of an embodiment of a host arrangement adapted for communicating with a terminal connected to an IP communication network.

FIG. 6 is an illustration of an embodiment of a first host adapted for communicating with a terminal connected to an IP communication network.

### DETAILED DESCRIPTION

Briefly described, a host arrangement and a method performed by the host arrangement for communicating with a terminal connected to an IP communication network, wherein the host arrangement comprises at least two hosts, whereof one is operating as active host and the remaining at least one host is operating as backup host(s) are provided. The host arrangement is connected to the IP communication network by means of a switch, wherein each host of the host arrangement is connected to the switch by means of an individual link, the active host being associated with an IP address and a Media Access Control, MAC, address. In case of a link failure between the active host and the switch, or a malfunction of the active host, the IP address and the MAC address of the active host is transferred to one of the backup hosts to take over from the active host. In this manner the need of having to update routers in the IP communication network due to the change of hosts is avoided.

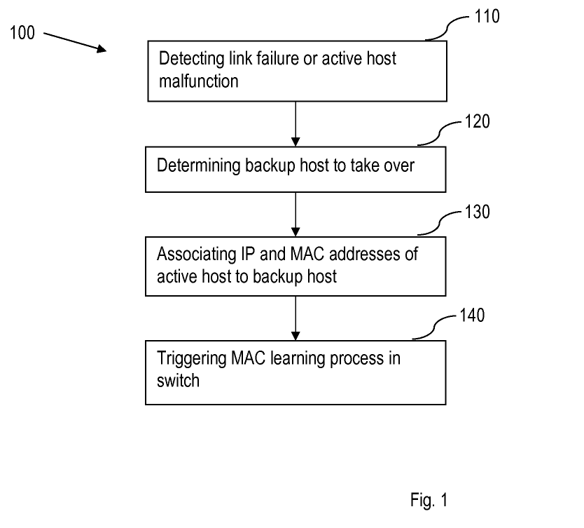

FIG. 1 is a flowchart of a method performed by a host arrangement for communicating with a terminal connected to an IP communication network according to an exemplifying embodiment. The host arrangement comprises at least two hosts, whereof one is operating as active host and the remaining at least one host is operating as backup host(s). The host arrangement is connected to the IP communication network by means of a switch, wherein each host of the host arrangement is connected to the switch by means of an individual link, the active host being associated with an IP address and a MAC address. FIG. 1 illustrates the method 100 comprising detecting 110 a link failure between the active host and the switch, or a malfunction of the active host; and determining 120 a backup host to take over from the active host. The method further comprises associating 130 the IP address and the MAC address of the active host to the determined backup host to take over from the active host; and triggering 140 a MAC learning process in the switch. In this manner the need for having to update routers in the IP communication network due to the change of hosts is avoided.

The host arrangement serves as an “End-system arrangement”, i.e. a terminating or an originating unit. The host arrangement comprises at least two hosts, whereof one is operating as active host and the remaining at least one host is operating as backup host(s). At a first point in time, the host arrangement is communicating with the terminal connected to the IP communication network. The host arrangement is connected to the IP communication network by means of a switch, wherein each host of the host arrangement is connected to the switch by means of an individual link, the active host being associated with an IP address and a MAC address. This means that traffic or data may be sent between the host arrangement and the terminal, wherein the host acting as active host is communicating with the terminal. At a second point in time, the host arrangement detects 110 a link failure between the active host and the switch, or a malfunction of the active host. The detection of the link failure between the active host and the switch, or the malfunction of the active host can be done in several different ways, which will be explained in more detail below. Once the host arrangement has determined either the link failure or malfunction of the active host, it is clear that the active host is no longer able to serve the terminal connected to the IP communication network.

In order for the host arrangement to be able to continue serving the terminal, or communicate with the terminal, the host arrangement determines 120 a backup host to take over from the active host. In the case of the host arrangement comprising only one backup host, it is obvious that the only backup host is determined to take over from the active host. In the case the host arrangement comprises several hosts operating as backup hosts, hereinafter referred to as just backup hosts, the host arrangement determines which one of these shall take over from the active host. Also the determination of which backup host to take over from the active host may be performed in different ways, which will be explained in more detail below.

The host arrangement then associates 130 the IP address and the MAC address of the active host to the determined backup host to take over from the active host. This means that the IP address and the MAC address of the active host will now represent the determined backup host to take over from the active host. In other words, any incoming traffic from the terminal via the switch comprising the IP address and the MAC address of the active host will not be delivered, by the switch, to the active host but instead to the determined backup host to take over from the active host since the addresses now belong to, or are associated with, the determined backup host to take over from the active host.

The host arrangement further triggers 140 a MAC learning process in the switch, which means that the host arrangement informs the switch that the IP address and the MAC address from now on are associated with the determined backup host to take over from the active host. In this manner, the need for having to update routers in the IP communication network due to the change of hosts is avoided. The MAC learning process is needed because the MAC address is move, or transferred, from the active host to the backup host, however, any updating of cashes of the routers in the IP communication network is not needed. The relation between the MAC address and the IP address is kept since both addresses are moved, or transferred. The MAC learning process may be an optimised function performed in hardware of the switch, whereas any update of routers in the IP network usually is performed by some sort of slow path protocol stack software.

The method may have several advantages. One advantage is that there may be no need for having to update routers in the IP communication network due to the change of hosts. This in turn reduces signalling and resource consumption of the routers in the IP communication network. Another advantage may be that robustness and reliability of the host arrangement may be increased since there is at least one host being able to take over from an active host in case of link failure or malfunction of the active host.

According to an embodiment, triggering 140 the MAC learning process in the switch is done by sending a packet to the terminal via the switch.

When the backup host sends a packet to the terminal in the IP communication network via the switch, the backup host will use its own dedicated link between the backup host and the switch. The packet sent to the terminal via the switch will comprise the IP address and the MAC address of the source, i.e. the backup host. In this manner, the switch is informed, or learns, that the link by means of which the switch receives the packet from the host arrangement, i.e. the backup host, from now shall be associated with the IP address and the MAC address of the source, i.e. the backup host. It shall be noted that the switch only looks at, or works with, the MAC address whereas routers in the IP communication network looks at, or works with, the IP address. The switch will thereafter forward any packet, data or traffic received from the terminal, or the IP communication network, destined for the host arrangement, to the backup host which has taken over from the active host.

According to an embodiment, detecting 110 the link failure between the active host and the switch, or the malfunction of the active host comprises the active host regularly sending status information messages to the backup host(s), wherein a detected absence of status information messages in the backup host(s) indicates the link failure or malfunction of the active host.

The active host may regularly send status information messages to the backup host(s) which may comprise some sort of information or which may be merely “empty” signals or pulses which indicate to the backup host(s) that the active host is alive and functioning properly.

The status information messages may be sent to the backup host(s) either by inbound or outbound signalling. Inbound signalling means that the active host sends the status information messages to the backup host(s) via the switch. This means that the active host sends the status information messages on its dedicated link to the switch, the status information messages having IP and MAC addresses of the backup host(s). It shall be pointed out that the active host may either send separate status messages for each individual backup host, or may make use of a multicast address which will address all of the backup hosts of the host arrangement. The switch receiving these messages will forward, or distribute, them to the backup host(s) using the IP and MAC addresses and the switch will forward them to the backup host(s) by means of a dedicated link between the switch and the backup host(s). It shall be pointed out that in one example, each backup host has its own dedicated link to the switch and in a second example, there is just one dedicated link between the switch and all of the backup host(s).

In case of inbound signalling, the backup host(s) may detect the absence of status information messages, and from such a detection, the backup host(s) are enabled to determine that either a link failure has occurred between the active host and the switch or a malfunction of the active host has occurred. The backup host(s) is not enabled to determine which of these two alternatives has occurred, and there is no need to distinguish between these two since regardless of which alternative has occurred, one of the backup hosts needs to take over.

In case of outbound signalling, the active host may send status information messages directly to the backup host(s) or to a control unit which is connected to the active and backup hosts. Also in this case, the absence of status information messages indicates the link failure or malfunction of the active host. However, in case of outbound signalling, the active host may detect a link failure itself and may either stop sending status information messages or may alternatively send an alarm to the backup host(s) or the control unit indicating that one of the backup hosts needs to take over from the active host.

As described above, the host arrangement determines which backup host to take over from the active host and associates 130 the IP address and the MAC address of the active host to the determined backup host to take over from the active host. This means that the previous associated IP and MAC address for the determined backup host to take over is replaced with the IP and MAC address of the active host.

According to still an embodiment, the host arrangement comprises at least two backup hosts, wherein each individual backup host is assigned an individual timer, the individual timers having different lengths, wherein determining 120 the backup host to take over from the active host comprises selecting the backup host which timer expires first from the point in time when the last status information messages was received from the active host.

In the case when the host arrangement comprises at least two backup hosts, the host arrangement should select which one to take over when determining 120 a backup host to take over from the active host. In this embodiment, the active host sends status information messages to the backup hosts in the host arrangement. Each of the backup hosts is assigned, or has, an individual timer, wherein the individual timers have different lengths. Each time the backup hosts receive a status information message, each of the backup hosts resets their individual timer and then each individual timers starts counting again. In case a new status information message is received before the expiration of the timer having the shortest length out of the different times, all timers are reset and start counting again. However, if no status message is received before the timer having the shortest length out of the different times expires, or lapses, an absence of status information messages is detected. In this example, the absence of status information messages is detected by the backup host having, or being assigned with, the timer having the shortest length out of the different times. Then the same backup host that detected the absence of status information messages, i.e. has the shortest timer, is determined to take over from the active host.

According to yet an embodiment, detecting 110 the link failure between the active host and the switch comprises the active host detecting the link failure, the active host determining a backup host to take over and the active host informing the determined backup host to take over.

In this embodiment, the active host comprises means for supervising the link between itself and the switch. At a point in time, the active host detects a link failure of the link between the active host and the switch. Due to the link failure, the active host is unable to communicate with the terminal connected to the IP communication network “on the other side of” the switch. By the other side of the switch means that the switch connects the host arrangement to the IP communication network, or an intermediate network between the switch and the IP communication network. Since the active host is unable to communicate with the terminal, the host arrangement is unable to communicate with the terminal. Consequently, a backup host needs to take over from the active host so that the host arrangement may communicate with the terminal.

In this embodiment, it is the active host that first detects 110 the link failure and due to this detection then determines 120 a backup host to take over from the active host. If there is only one backup host, then that backup host is selected. In case there are two or more backup host comprised in the host arrangement, then the active host determines, or selects, which one of the backup hosts that shall take over from the active host. How the active host actually performs the determination, or selection, of the backup host to take over from the active host may be done in different ways, as will be explained in more detail below.

Once the active host has determined 120 which backup host to take over from the active host, the active host informs the determined backup host to take over. When the active host informs the determined backup host to take over, the active host may in one example also inform the backup host of the IP address and the MAC address of the active host so that the backup host will use these addresses henceforth. In another example, the backup host(s) knows the IP address and the MAC address of the active host, and if a backup host is informed that is shall take over from the active host, the backup host discontinues using its own IP address and MAC address and starts using the IP address and the MAC address of the active host. In other words, the backup host replaces its own IP address and the MAC address with those of the active host, at least for as long as the backup host is operating on behalf of the, or as an, active host. In this manner, the backup host is associated 130 with the IP address and the MAC address of the active host.

According to still an embodiment, the host arrangement comprises a control unit, the method comprising the active host informing the control unit of the detected link failure, wherein the control unit determines a backup host to take over and the control unit informing the determined backup host to take over.

When the host arrangement comprises a control unit, the control unit may be connected to all hosts, and optionally other entities/components, of the host arrangement. As described above, the active host may comprise means for supervising the link between itself and the switch. At a point in time, the active host detects a link failure of the link between the active host and the switch. In order for the host arrangement to be able to communicate with the terminal, a backup host to take over from the active host must be determined and be assigned the IP address and the MAC address of the active host. Instead of the active host determining 120 a backup host to take over from the active host, the active host informs the control unit of the host arrangement of the detected link failure. Then the control unit performs the determination 120 of the backup host to take over from the active host and informs the determined backup host to take over. Just as in the embodiment of the active host informing the backup host to take over from the active host, the control unit may inform the backup host of the IP address and the MAC address of the active host, or the backup host(s) knows the IP address and the MAC address of the active host. Once the determined backup host to take over from the active host is informed that it shall take over, it will henceforth use the IP address and the MAC address of the active host. In this manner, the backup host is associated 130 with the IP address and the MAC address of the active host.

In the case the host arrangement comprises a control unit, and in case the active host malfunctions, the control unit is arranged to detect the malfunction of the active host and then take the necessary actions, as described above, to determine a backup host to take over, assign the IP address and the MAC address of the active host to the determined backup host. One example of how the control unit is arranged to detect the malfunction of the active host is by way of timers as described above to the backup host(s). The active host is arranged to regularly send status information messages to the control unit. The control unit comprises a timer of a predetermined length, which is reset upon reception of a status information message. In case the timer expires before a status information message is received, the control unit detects that the active hosts malfunctions and takes the necessary actions to ascertain that the host arrangement is able to communicate with the terminal by means of a backup host. Alternatively, the control unit may poll the active host regularly and in the case the active host does not respond to the poll, the control unit detects the malfunction of the active host.

According to still an embodiment, the active host or the control unit sends the IP address and the MAC address of the active host to the determined backup host.

According to yet an embodiment, the host arrangement comprises at least two backup hosts, wherein each individual backup host is assigned different priorities, wherein determining the backup host to take over from the active host comprises selecting the backup host with the highest priority.

As stated above, there are several ways of determining a, or which, backup host to take over from the active host in case the active host malfunctions or a link failure is detected on the active link, i.e. the link between the active host and the switch. One way is to assign different priorities to the backup hosts of the host arrangement. Then, in case a backup host needs to take over from the active host, the backup host with the highest priority is selected. Should, for some reason, the backup host with the highest priority not being able to take over from the backup host, then the backup host with the second highest priority is selected. The selection, or determination, of which backup host that shall take over from the active host may be done by e.g. the active host or the control unit.

According to an embodiment, the at least two hosts are located on at least two individual physical devices or the same physical device.

In the case the at least two hosts, i.e. the active host and the at least one backup host are the same physical device, then the host arrangement is a physical device which comprises the at least two hosts. In the case the at least two hosts are at least two individual physical devices, then the host arrangement is physically distributed so that the at least two hosts are located at different geographical places, or separated as two independent physical units. It shall be pointed out that the different geographical places may be very close or very far from each other, in other words, there is no limitation of the distance between the different geographical places.

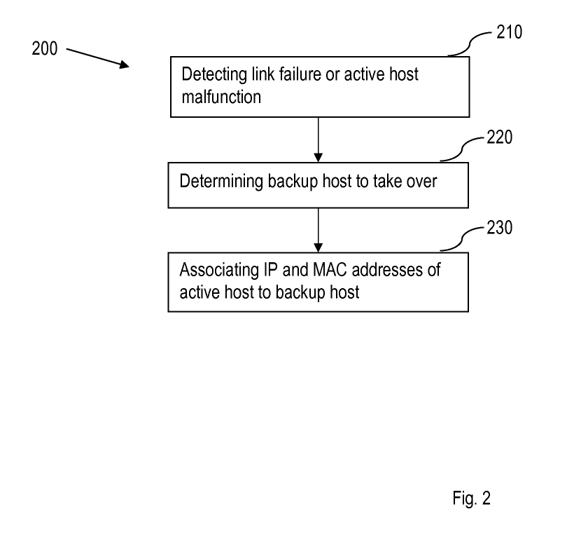

Embodiments herein also relate to a method performed by a first host, operable to be associated with a second host, the hosts being adapted for communicating with a terminal connected to an IP communication network. Exemplifying embodiments of such a method will now be described with reference to FIG. 2.

The first and the second host are connectable to the IP communication network by means of a switch, wherein each host is connectable to the switch by means of an individual link, wherein one of the hosts is operating as active host and the other host is operating as backup host. FIG. 2 illustrates the method comprising detecting 210 a link failure between the active host and the switch, or a malfunction of the active host; determining 220 a backup host to take over from the active host; and associating 230 the IP address and the MAC address of the active host to the determined backup host to take over.

At a first point in time, one of the first and the second host is acting as the active host and is communicating with the terminal. In other words, the first host may either be the active host or the backup host.

At a second point in time, the first host detects 210 a link failure between the active host and the switch, or a malfunction of the active host. The detection of the link failure between the active host and the switch, or the malfunction of the active host can be done in several different ways, as has been described above. Once the first host has determined either the link failure or malfunction of the active host, it is clear that the active host is not able to serve the terminal connected to the IP communication network. Regardless of the first host being the active host or the backup host, the first host detects the link failure or the malfunction of the active host.

In order for the first host or the second to be able to continue to serve the terminal, or communicate with the terminal, the first host determines 220 a backup host to take over from the active host. In the case the first host is the active host, the first host determines that the second host shall take over. In the case the first host is the backup host, the first host determines that itself shall take over.

The first host then associates 230 the IP address and the MAC address of the active host to the determined backup host to take over from the active host. This means that the IP address and the MAC address of the active host will now represent the determined backup host to take over from the active host. In other words, any incoming traffic from the terminal via the switch comprising the IP address and the MAC address of the active host will not be delivered, by the switch, to the active host but instead to the determined backup host to take over from the active host since the addresses now belongs to, or are associated with, the determined backup host to take over from the active host.

The method may have several advantages. One advantage is that there may be no need for having to update routers in the IP communication network due to the change of hosts. This in turn reduces signalling and resource consumption of the routers in the IP communication network. Another advantage may be that robustness and reliability of the host arrangement may be increased since there is at least one host being able to take over from an active host in case of link failure or malfunction of the active host.

According to an embodiment, the first host is the backup host.

According to an embodiment, wherein the first host is the backup host, detecting 210 the link failure between the active host and the switch, or the malfunction of the active host comprises detecting an absence of status information messages.

The active host may regularly send status information messages to the backup host, i.e. the first host in this embodiment, which may comprise some sort of information or which may be merely “empty” signals or pulses which indicate to the first host that the active host is alive and functioning properly.

The status information messages may be sent to the first host either by inbound or outbound signalling. Inbound signalling means that the active host sends the status information messages to the first host via the switch. This means that the active host sends the status information messages on its dedicated link to the switch, the status information messages having IP and MAC addresses of the first host. The switch receiving these messages will route them to the first host using the IP and MAC addresses and the switch will forward them to the first host by means of a dedicated link between the switch and the first host.

In case of inbound signalling, the first host may detect the absence of status information messages, and from such a detection the first host is enabled to determine that either a link failure has occurred between the active host and the switch or a malfunction of the active host has occurred. The first host is not enabled to determine which of these two alternatives has occurred, and there is no need to distinguish between these two since regardless of which alternative has occurred, the first host needs to take over.

In case of outbound signalling, the active host may send status information messages directly to the first host or to a control unit which is connected to the active and first host. Also in this case, the absence of status information messages indicates the link failure or malfunction of the active host. However, in case of outbound signalling, the active host may detect a link failure itself and may either stop sending status information messages or may alternatively send an alarm to the first host or the control unit indicating that the first host needs to take over from the active host.

The first host then associates 230 the IP address and the MAC address of the active host to itself. This means that the previous associated IP and MAC address for the first host is replaced with the IP and MAC address of the active host.

According to yet an embodiment, wherein the first host is the backup host, the method further comprises starting a timer of a predetermined length upon reception of a status information message from the active host, wherein if the timer expires before a subsequent status information message is received, the method comprises determining that a link failure between the active host and the switch, or the malfunction of the active host has occurred.

In the case, the active host sends status information messages to the first host. The first host comprises, or is associated with, a timer of a predetermined length. Each time the first host receives a status information message from the active host, the first host resets the timer and then starts the timer again so that the timer starts counting again.

In case a new status information message is received before the expiration of the timer the timer is reset and starts counting again. However, if no status message is received before the timer expires, or lapses, an absence of status information messages is detected.

According to still an embodiment, wherein the first host is the backup host, detecting the link failure between the active host and the switch, or the malfunction of the active host comprises receiving a notification message from the active host or from the control unit.

As previously described, the active host may be arranged to detect a link failure of the active link, i.e. the link between the active host and the switch. The active host may then inform either the control unit or the backup host, i.e. the first host of the detected link failure. In case the active host informs the control unit, the control unit may then subsequently inform the backup/first host of the detected link failure. The control unit may also be configured to detect the malfunction of the active host, by means of e.g. status information messages sent from the active host to the control unit. In case the control unit does not receive a status information message within a predefined time period, the control unit detects an absence of status information messages and consequently determines that a malfunction of the active host has occurred and then notifies the first host about the malfunction of the active host.

According to an embodiment, the notification message from the active host or from the control unit comprises the IP address and the MAC address of the active host.

When the active host or the control unit informs the first host to take over, the active host may in one example also inform the first host of the IP address and the MAC address of the active host so that the first host will use these addresses henceforth. In another example, the first host knows the IP address and the MAC address of the active host, and if a first host is informed that is shall take over from the active host, the first host discontinues using its own IP address and MAC address and starts using the IP address and the MAC address of the active host.

Embodiments herein also relate to a host arrangement adapted for communicating with a terminal connected to an IP communication network. The host arrangement has the same objects, technical features and advantages as the method performed by the host arrangement. The host arrangement will only be described in brief in order to avoid unnecessary repetition.

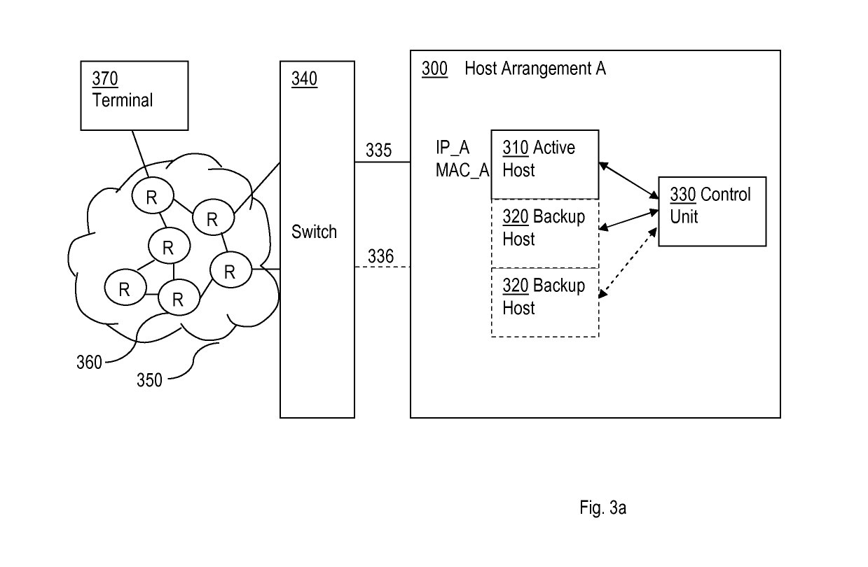

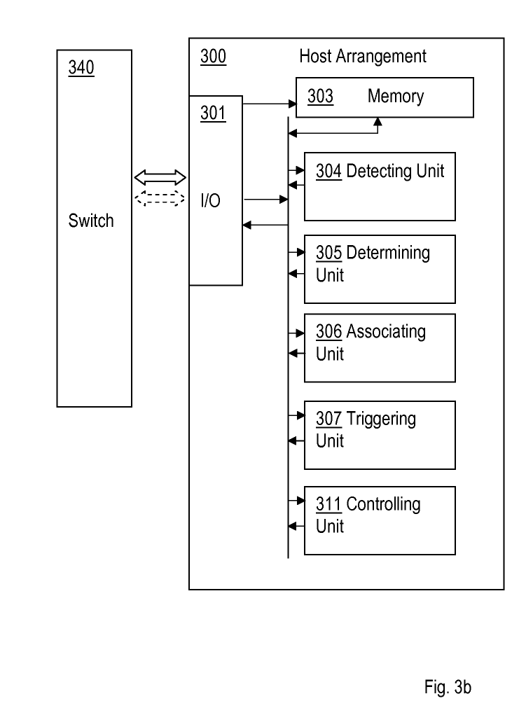

The host arrangement will now be described with reference to FIG. 3a, which is a block diagram schematically illustrating the host arrangement according to an exemplifying embodiment; and with reference to FIG. 3b which is a block diagram schematically illustrating the host arrangement according to an exemplifying embodiment.

FIG. 3a illustrates the host arrangement 300 comprising at least two hosts 310, 320, whereof one is operating as active host 310 and the remaining at least one host is operating as backup host(s) 320. The host arrangement 300 is connected to the IP communication network 350 by means of a switch 340, wherein each host 310, 320 of the host arrangement is connected to the switch by means of an individual link 335, 336. The active host is associated with an IP address and a MAC address.

FIG. 3b illustrates the host arrangement 300 comprising a detecting unit 304 adapted to detect a link failure between the active host 310 and the switch 340, or a malfunction of the active host 310. The host arrangement further comprises a determining unit 305 adapted to determine a backup host 320 to take over from the active host 310; and an associating unit 306 adapted to associate the IP address and the MAC address of the active host 310 to the determined backup host 320 to take over. The host arrangement also comprises a triggering unit 307 adapted to trigger a MAC learning process in the switch 340.

In the host arrangement, the different units, i.e. the detecting, determining, associating, triggering and control unit may be distributed within the host arrangement. As has been described above, in some embodiments, the active host is arranged to determine a link failure. In such an embodiment, the detecting unit 304 may be comprised in the active host 310. In some embodiments, the control unit 330 is arranged to detect the malfunction of the active host or the link failure, hence the detecting unit 304 may be comprised in the control unit 330. In still some embodiments, the backup host(s) is/are arranged to detect the malfunction of the active host or the link failure, hence the detecting unit 304 may be comprised in the backup host(s) 320. Depending on the different embodiments described above with reference to FIGS. 1 and 2, the different units may be comprised, or implemented, in either the active host 310, the backup host(s) 320 or the control unit 330 of FIG. 3a. Different units may further be comprised, or implemented, in different entities (the active host 310, the backup host(s) 320 or the control unit 330 of FIG. 3a) or all in the same entity.

The host arrangement may have several advantages. One advantage is that there may be no need for having to update routers in the IP communication network due to the change of hosts. This in turn reduces signalling and resource consumption of the routers in the IP communication network. Another advantage may be that robustness and reliability of the host arrangement may be increased since there is at least one host being able to take over from an active host in case of link failure or malfunction of the active host.

According to an embodiment, the triggering unit 307 is adapted to send a packet to the terminal via the switch 340 in order to trigger the MAC learning process in the switch.

After the determined backup host to take over from the active host has been associate with the IP address and the MAC address of the active host, the backup host sends a packet to the terminal via the switch 340 in order to trigger the MAC learning process in the switch. Therefore, in this embodiment, the triggering unit 307 is comprised, or implemented, in the backup host 320.

According to still an embodiment, the detecting unit 304 is adapted to detect the link failure between the active host 310 and the switch 340, or the malfunction of the active host 310 by the active host being adapted to regularly send status information messages to the backup host(s) 320, wherein a detected absence of status information messages in the backup host(s) 320 indicates the link failure or malfunction of the active host 310.

How this may be performed has been described in detail above. In such an embodiment, the detecting unit 304 may be comprised, or implemented, in the backup host 320.

According to yet an embodiment, the host arrangement comprises at least two backup hosts, wherein each individual backup host is assigned an individual timer, the individual timers having different lengths, wherein the determining unit 305 is adapted to determine the backup host to take over from the active host by selecting the backup host which timer expires first from the point in time when the last status information messages was received from the active host.

Each of the at least two backup hosts may comprise an individual determining unit. The respective determining unit may e.g. be arranged to control a respective timer. In case a timer in one of the backup hosts expires, the determining unit 305 of that backup host determines that its backup host is to take over from the active host.

Alternatively, the control unit 330 comprises the determining unit 305 and the control unit 330 controls the respective timers of the backup hosts, and in case a timer associated with one specific backup host expires due to the absence of a status information message, the control unit 330 determines that the specific backup host associated with the timer that expired shall be the one to take over from the active host.

According to an embodiment, the detecting unit 304 is comprised in the active host 310 and is adapted to detect the link failure between the active host and the switch 340, wherein the determining unit 305 is comprised in the active host 310 and is adapted to determine a backup host to take over, wherein the associating unit 306 is comprised in the active host 310 and is adapted to inform the determined backup host to take over.

According to another embodiment, the host arrangement further comprises a control unit 330, wherein the active host 310 is adapted to inform the control unit 330 of the detected link failure, wherein the control unit 230 is adapted to determine a backup host 320 to take over and the control unit 330 further being adapted to inform the determined backup host 320 to take over.

According to still an embodiment, the active host 310 or the control unit 330 is adapted to send the IP address and the MAC address of the active host to the determined backup host 320.

According to yet an embodiment, the host arrangement comprises at least two backup hosts, wherein each individual backup host is assigned different priorities, wherein the determining unit 305 is adapted to determine the backup host to take over from the active host by selecting the backup host with the highest priority.

In this case, either the active host 310 or the control unit 330 may comprise the determining unit 305.

According to an embodiment, the at least two hosts are located on at least two individual physical devices or the same physical device.

Embodiments herein also relate to a virtual host comprising a host arrangement as described above. The virtual host will operate as an “End-system arrangement”, i.e. a terminating or an originating unit. This means that to any terminal or node in, or connected to, the IP communication network, the virtual host appears as one entity with one MAC address and one IP address. The virtual host may comprise a plurality of hosts, or end-servers, but to any node or terminal node in, or connected to, the IP communication network, the virtual host appears as one entity and any switching between hosts in the virtual host is invisible outside of the virtual host.

Embodiments herein also relate to a first host operable to be associated with a second host 420, the hosts being adapted for communicating with a terminal connected to an IP communication network. The first host has the same object, technical features and advantages as the method performed by the first host, described above. The first host will only be described in brief in order to avoid unnecessary repetition.

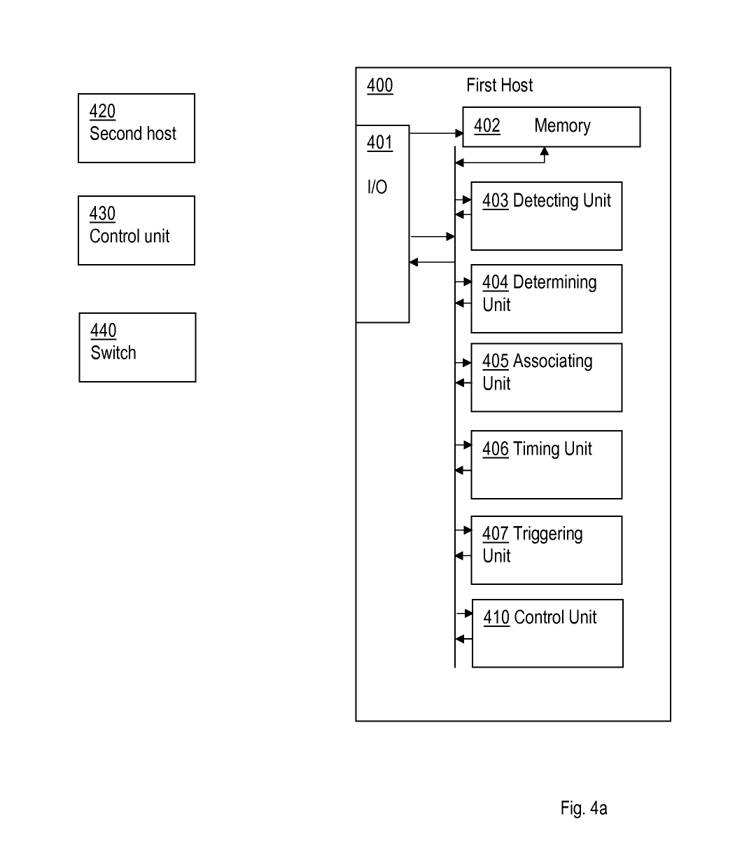

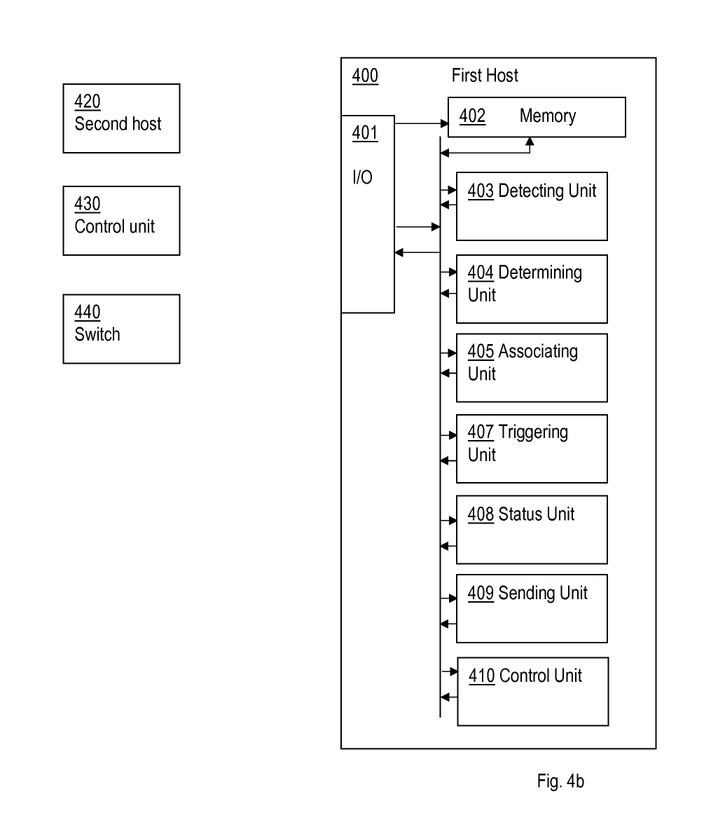

A first host will now be described with reference to FIGS. 4a and 4b. FIGS. 4a and 4b are block diagram of embodiments of a first host adapted for communicating with a terminal connected to an IP communication network.

The first and the second host are connectable to the IP communication network by means of a switch 440, wherein each host is connectable to the switch by means of an individual link, wherein one of the hosts is operating as active host and the other host is operating as backup host. FIGS. 4a and 4b illustrate the first host comprising a detecting unit 403 adapted to detect a link failure between the active host and the switch 440, or a malfunction of the active host. The first host further comprises a determining unit 404 adapted to determine a backup host to take over from the active host; and an associating unit 405 adapted to associate the IP address and the MAC address of the active host to the determined backup host to take over.

The first host may have several advantages. One advantage is that there may be no need for having to update routers in the IP communication network due to the change of hosts. This in turn reduces signalling and resource consumption of the routers in the IP communication network. Another advantage may be that robustness and reliability of the host arrangement may be increased since there is at least one host being able to take over from an active host in case of link failure or malfunction of the active host.

According to an embodiment, the first host is the backup host.

Embodiments wherein the first host is the backup host will now be described with reference to FIG. 4a.

According to an embodiment, wherein the first host is the backup host, the detecting unit 403 is adapted to detect the link failure between the active host and the switch 440, or the malfunction of the active host by detecting an absence of status information messages.

According to still an embodiment, wherein the first host is the backup host, the first host further comprises a timing unit 406 adapted to start a timer of a predetermined length upon reception of a status information message from the active host, wherein if the timer expires before a subsequent status information message is received, then the detecting unit 403 is adapted to detect the link failure between the active host and the switch 440, or the malfunction of the active host.

According to yet an embodiment, wherein the first host is the backup host, the detecting unit 403 is adapted to detect the link failure between the active host and the switch, or the malfunction of the active host by receiving a notification message from the active host or from a control unit 410.

According to a further embodiment, wherein the first host is the backup host, the notification message from the active host or from the control unit comprises the IP address and the MAC address of the active host.

According to still an embodiment, wherein the first host is the backup host, the first host further comprises a memory 402 having the IP address and the MAC address of the active host stored therein.

According to yet an embodiment, wherein the first host is the backup host, the first host further comprises a triggering unit 407 adapted to trigger a MAC learning process in the switch.

According to another embodiment, the first host is the active host.

Embodiments wherein the first host is the active host will now be described with reference to FIG. 4b.

According to an embodiment, wherein the first host is the active host, the first host comprises a status unit 408 adapted to send status messages to the backup host.

According to still an embodiment, wherein the first host is the active host, the status unit 408 further is adapted to send a poll message towards the switch, wherein the detecting unit 403 adapted to detect a link failure between the active host and the switch 440 if no response to the poll message is received via the switch 440.

This is an example of the active host, i.e. the first host in this embodiment, is adapted to detect link failure on the link between the active host and the switch. If the link is ok, the switch will receive the poll message from the active host and return either the poll message itself or the switch will generate some kind of response message and send that message back to the active host. In case the active host sends a poll message to the switch and does not receive a response within a predetermined time, then the active host, i.e. the first host, may detect that a link failure has occurred.

According to yet an embodiment, wherein the first host is the active host, the first host further comprises a sending unit 409 adapted to send a notification message to a control unit or to the backup host, the notification message informing the control unit 410 or the backup host about the link failure between the active host and the switch 440.

According to an embodiment, wherein the first host is the active host, the notification message further comprises the IP address and the MAC address of the active host.

During the backup host operating instead of the active host in order to communicate with the terminal connected to the IP communication network, the active host (which now is not operating due either to a link failure or a malfunction) is in one example supervised, e.g. by the control unit, in order to detect a possible rectification of the fault resulting in the backup host taking over. Alternatively, in case of a link failure, the active host may itself supervise the link between itself and the switch in order to detect that the link has been restored. In case the active host, or the control unit, detects that the active host is enabled to resume operation, i.e. support the communication between the host arrangement and the terminal in the IP communication network, the active host takes over from the backup host. This can be performed in different ways. In one example, the active host or the control unit informs the backup host that the active host is to take over, wherein the backup host terminates operating instead of the active host and the backup host is associated with the MAC address and the IP address it had before it was associated with the MAC address and the IP address of the active host. In other words, the MAC address and the IP address of the active host is returned to, or associated anew, to the active host and the active host may trigger a MAC learning process in the switch. In this manner, the need for having to update routers in the IP communication network due to the change of hosts is again avoided. It can be seen that the host arrangement may change hosts at its own volition without affecting any entity outside the host arrangement.

On the “other side of” the switch, i.e. in the network 350 of FIG. 3a, the different routers 360 may employ a Virtual Router Redundancy Protocol, VRRP or similar redundancy functions/protocols. A number of neighbouring routers are treated as a group, with one router being master, and the others providing backup. A participating host uses the so called virtual router as its default gateway, and has no knowledge about the physical routers. The virtual router has the same IP address (IPv4 address or link local IPv6 address) as the master router. The MAC address of the virtual router is determined based on a configured virtual router identity, and is not identical to the MAC address of any physical interface of any of the routers in the group. VRRP is one example of a redundancy protocol for routers.

In FIG. 3b, the host arrangement 300 is also illustrated comprising an interface unit 301. Through this unit, the host arrangement 300 is adapted to communicate with the switch connecting the host arrangement 300 to the IP communication network 350. The interface unit 301 may comprise more than one receiving and transmitting arrangement. For example, the interface unit 301 may be connected to the switch 340 by several physical links, by means of which the host arrangement 300 is enabled to communicate, via the switch 340, with other nodes and/or entities in the IP communication network. The host arrangement 300 further comprises a memory 303 for storing data, e.g. MAC and IP addresses. Further, the host arrangement 300 is illustrated comprising a controlling 311 which in turns is connected to the different units 304-307. It shall be pointed out that this is merely an illustrative example and the host arrangement 300 may comprise more, less or other units or modules which execute the functions of the host arrangement 300 in the same manner as the units illustrated in FIG. 3b.

It should be noted that FIG. 3b merely illustrates various functional units in the host arrangement 300 in a logical sense. The functions in practice may be implemented using any suitable software and hardware means/circuits etc. Thus, the embodiments are generally not limited to the shown structures of the host arrangement 300 and the functional units. Hence, the previously described exemplary embodiments may be realised in many ways. For example, one embodiment includes a computer-readable medium having instructions stored thereon that are executable by the controlling unit 311 for executing the method steps in the host arrangement 300. The instructions executable by the computing system and stored on the computer-readable medium perform the method steps of the host arrangement 300 as set forth in the claims.

In FIGS. 4a and 4b, the first host 400 is also illustrated comprising an interface unit 401. Through this unit, the first host 400 is adapted to communicate with the switch 440 connecting the first host 400 to the IP communication network. The interface unit 401 may comprise more than one receiving and transmitting arrangement. For example, the interface unit 401 may be connected to the switch 440 by a physical link, by means of which the first host 400 is enabled to communicate, via the switch 440, with other nodes and/or entities in the IP communication network. The first host 400 further comprises a memory 402 for storing data, e.g. MAC and IP addresses. Further, the first host may comprise a control unit 410 which in turns is connected to the different 403-409. It shall be pointed out that this is merely an illustrative example and the first host 400 may comprise more, less or other units or modules which execute the functions of the first host 400 in the same manner as the units illustrated in FIGS. 4a and 4b.

It should be noted that FIGS. 4a and 4b merely illustrate various functional units in the first host 400 in a logical sense. The functions in practice may be implemented using any suitable software and hardware means/circuits etc. Thus, the embodiments are generally not limited to the shown structures of the first host 400 and the functional units. Hence, the previously described exemplary embodiments may be realised in many ways. For example, one embodiment includes a computer-readable medium having instructions stored thereon that are executable by the control unit 410 for executing the method steps in the first host 400. The instructions executable by the computing system and stored on the computer-readable medium perform the method steps of the first host 400 as set forth in the claims.

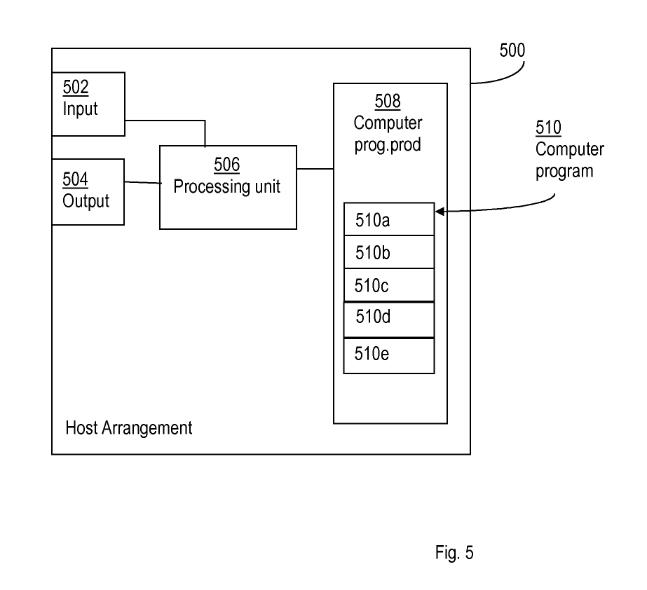

FIG. 5 schematically shows an embodiment of a first host 500. Comprised in the first host 500 are here a processing unit 506, e.g. with a DSP (Digital Signal Processor). The processing unit 506 may be a single unit or a plurality of units to perform different actions of procedures described herein. The first host 500 may also comprise an input unit 502 for receiving signals from other entities, and an output unit 504 for providing signal(s) to other entities. The input unit and the output unit may be arranged as an integrated entity or as illustrated in the example of FIG. 3b, as the interface unit 301.

Furthermore, the first host 500 comprises at least one computer program product 508 in the form of a non-volatile memory, e.g. an EEPROM (Electrically Erasable Programmable Read-Only Memory), a flash memory and a hard drive. The computer program product 508 comprises a computer program 510, which comprises code means, which when executed in the processing unit 506 in the first host 500 causes the first host 500 to perform the actions e.g. of the procedure described earlier in conjunction with FIG. 1.

The computer program 510 may be configured as a computer program code structured in computer program modules 510a-510e. Hence, in an exemplifying embodiment, the code means in the computer program of the first host 500 comprises a detecting unit, or module, for detecting a link failure between the active host and the switch, or a malfunction of the active host. The computer program further comprises a determining unit, or module, for determining a backup host to take over from the active host; and an associating unit, or module, for associating the IP address and the MAC address of the active host to the determined backup host to take over from the active host. The computer program further comprises a triggering unit, or module, for triggering (140) a MAC learning process in the switch.

The computer program modules could essentially perform the actions of the flow illustrated in FIG. 1, to emulate the first host 500. In other words, when the different computer program modules are executed in the processing unit 506, they may correspond to the units 304-307 of FIG. 3b.

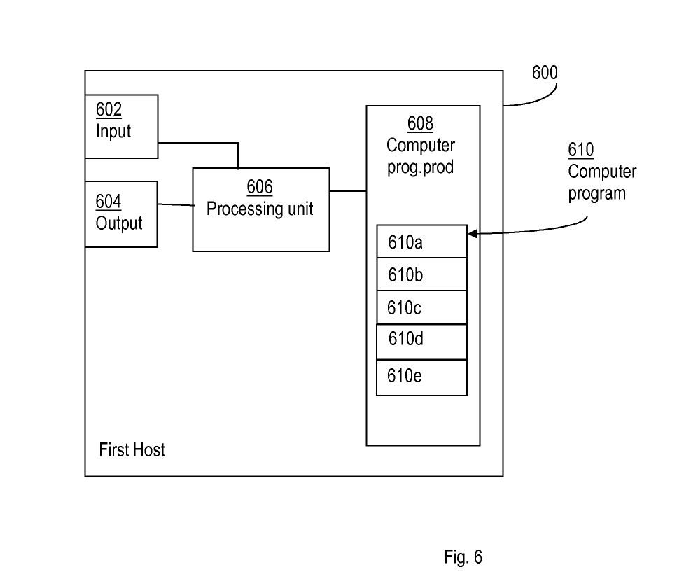

FIG. 6 schematically shows an embodiment of a first host 600. Comprised in the first host 600 are here a processing unit 606, e.g. with a DSP (Digital Signal Processor). The processing unit 606 may be a single unit or a plurality of units to perform different actions of procedures described herein. The first host 600 may also comprise an input unit 602 for receiving signals from other entities, and an output unit 604 for providing signal(s) to other entities. The input unit and the output unit may be arranged as an integrated entity or as illustrated in the example of FIGS. 4a and 4b, as the interfaces 401.

Furthermore, the first host 600 comprises at least one computer program product 608 in the form of a non-volatile memory, e.g. an EEPROM (Electrically Erasable Programmable Read-Only Memory), a flash memory and a hard drive. The computer program product 608 comprises a computer program 610, which comprises code means, which when executed in the processing unit 606 in the first host 600 causes the first host 600 to perform the actions e.g. of the procedure described earlier in conjunction with FIG. 2.

The computer program 610 may be configured as a computer program code structured in computer program modules 610a-610e. Hence, in an exemplifying embodiment, the code means in the computer program of the first host 600 comprises a detecting unit, or module, for detecting a link failure between the active host and the switch, or a malfunction of the active host. The computer program further comprises a determining unit, or module, for determining, a backup host to take over from the active host. The computer program further comprises an associating unit, or module, for associating (230) the IP address and the MAC address of the active host to the determined backup host to take over.

The computer program modules could essentially perform the actions of the flow illustrated in FIG. 2, to emulate the first host 600. In other words, when the different computer program modules are executed in the processing unit 606, they may correspond to the units 403-409 of FIGS. 4a and 4b.

Although the code means in the respective embodiments disclosed above in conjunction with FIGS. 5 and 6 are implemented as computer program modules which when executed in the respective processing unit causes the host arrangement and the first host respectively to perform the actions described above in the conjunction with figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as ASICs (Application Specific Integrated Circuit). The processor may also comprise board memory for caching purposes. The computer program may be carried by a computer program product connected to the processor. The computer program product may comprise a computer readable medium on which the computer program is stored. For example, the computer program product may be a flash memory, a RAM (Random-access memory) ROM (Read-Only Memory) or an EEPROM, and the computer program modules described above could in alternative embodiments be distributed on different computer program products in the form of memories within the Network Node and the UE respectively.

It is to be understood that the choice of interacting units, as well as the naming of the units within this disclosure are only for exemplifying purpose, and nodes suitable to execute any of the methods described above may be configured in a plurality of alternative ways in order to be able to execute the suggested procedure actions.

It should also be noted that the units described in this disclosure are to be regarded as logical entities and not with necessity as separate physical entities.

While the embodiments have been described in terms of several embodiments, it is contemplated that alternatives, modifications, permutations and equivalents thereof will become apparent upon reading of the specifications and study of the drawings. It is therefore intended that the following appended claims include such alternatives, modifications, permutations and equivalents as fall within the scope of the embodiments and defined by the pending claims

1. A method performed by a host arrangement for communicating with a terminal connected to an Internet Protocol (IP) communication network, the host arrangement comprising at least two hosts, whereof one is operating as active host and the remaining at least one host(s) is operating as backup host(s), the host arrangement being connected to the IP communication network by means of a switch, wherein each host of the host arrangement is connected to the switch by means of an individual link, the active host being associated with an IP address and a Media Access Control (MAC) address, the method comprising:
detecting a link failure between the active host and the switch, or a malfunction of the active host;
determining a backup host to take over from the active host;
associating the IP address and the MAC address of the active host to the determined backup host to take over from the active host; and
triggering a MAC learning process in the switch,
thus avoiding having to update routers in the IP communication network due to the change of hosts.

2. The method according to claim 1, wherein the triggering of the MAC learning process in the switch is done by sending a packet to the terminal via the switch.

3. The method according to claim 1, wherein detecting the link failure between the active host and the switch, or the malfunction of the active host comprises the active host regularly sending status information messages to the backup host(s), wherein a detected absence of status information messages in the backup host(s) indicates the link failure or malfunction of the active host.

4. The method according to claim 3, wherein the host arrangement comprises at least two backup hosts, wherein each individual backup host is assigned an individual timer, the individual timers having different lengths, wherein determining the backup host to take over from the active host comprises selecting the backup host which timer expires first from the point in time when the last status information messages was received from the active host.

5. The method according to claim 1, wherein detecting the link failure between the active host and the switch comprises the active host detecting the link failure, the active host determining a backup host to take over and the active host informing the determined backup host to take over.

6. The method according to claim 1, wherein the host arrangement comprises a control unit, the method comprising the active host informing the control unit of the detected link failure, wherein the control unit determines a backup host to take over and the control unit informing the determined backup host to take over.

7. The method according to claim 5, wherein the active host or the control unit sends the IP address and the MAC address of the active host to the determined backup host.

8. The method according to claim 5, wherein the host arrangement comprises at least two backup hosts, wherein each individual backup host is assigned different priorities, wherein determining the backup host to take over from the active host comprises selecting the backup host with the highest priority.

9. The method (100) according to claim 1, wherein the at least two hosts are located on at least two individual physical devices or the same physical device.

10. A method performed by a first host, operable to be associated with a second host, the hosts being adapted for communicating with a terminal connected to an Internet Protocol (IP) communication network, the first and the second host being connectable to the IP communication network by means of a switch, wherein each host is connectable to the switch by means of an individual link, wherein one of the hosts is operating as active host and the other host is operating as backup host, the method comprising:
detecting a link failure between the active host and the switch, or a malfunction of the active host;
determining a backup host to take over from the active host; and
associating the IP address and the MAC address of the active host to the determined backup host to take over.

11. The method according to claim 10, wherein the first host is the backup host.

12. The method according to claim 10, wherein detecting the link failure between the active host and the switch, or the malfunction of the active host comprises detecting an absence of status information messages.

13. The method according to claim 12, further comprising starting a timer of a predetermined length upon reception of a status information message from the active host, wherein if the timer expires before a subsequent status information message is received, the method comprises determining that a link failure between the active host and the switch, or the malfunction of the active host has occurred.

14. The method according to claim 10, wherein detecting the link failure between the active host and the switch, or the malfunction of the active host comprises receiving a notification message from the active host or from the control unit.

15. The method according to claim 14, wherein the notification message from the active host or from the control unit comprises the IP address and the MAC address of the active host.

16. A host arrangement adapted for communicating with a terminal connected to an Internet Protocol (IP) communication network, the host arrangement comprising at least two hosts, whereof one is operating as active host and the remaining at least one host is operating as backup host(s), the host arrangement being connected to the IP communication network by means of a switch, wherein each host of the host arrangement is connected to the switch by means of an individual link, the active host being associated with an IP address and a Media Access Control (MAC) address, the host arrangement comprising:
a detecting unit adapted to detect a link failure between the active host (310) and the switch, or a malfunction of the active host;
a determining unit adapted to determine a backup host to take over from the active host;
an associating unit adapted to associate the IP address and the MAC address of the active host to the determined backup host to take over; and
a triggering unit adapted to trigger a MAC learning process in the switch.

17. The host arrangement according to claim 16, wherein the triggering unit is adapted to send a packet to the terminal via the switch in order to trigger the MAC learning process in the switch.

18. The host arrangement according to claim 16, wherein the detecting unit is adapted to detect the link failure between the active host and the switch, or the malfunction of the active host by the active host being adapted to regularly send status information messages to the backup host(s), wherein a detected absence of status information messages in the backup host(s) indicates the link failure or malfunction of the active host.

19. The host arrangement according to claim 16, wherein the host arrangement comprises at least two backup hosts, wherein each individual backup host is assigned an individual timer, the individual timers having different lengths, wherein the determining unit is adapted to determine the backup host to take over from the active host by selecting the backup host which timer expires first from the point in time when the last status information messages was received from the active host.

20. The host arrangement according to claim 16, wherein the detecting unit is comprised in the active host and is adapted to detect the link failure between the active host and the switch, wherein the determining unit is comprised in the active host and is adapted to determine a backup host to take over, wherein the associating unit is comprised in the active host and is adapted to inform the determined backup host to take over.

21. The host arrangement according to claim 16, wherein the host arrangement further comprises a control unit, wherein the active host is adapted to inform the control unit of the detected link failure, wherein the control unit is adapted to determine a backup host to take over and the control unit further being adapted to inform the determined backup host to take over.

22. The host arrangement according to claim 20, wherein the active host or the control unit is adapted to send the IP address and the MAC address of the active host to the determined backup host.

23. The host arrangement according to claim 20, wherein the host arrangement comprises at least two backup hosts, wherein each individual backup host is assigned different priorities, wherein the determining unit is adapted to determine the backup host to take over from the active host by selecting the backup host with the highest priority.

24. The host arrangement according to claim 16, wherein the at least two hosts are located on at least two individual physical devices or the same physical device.

25. (canceled)

26. A first host operable to be associated with a second host, the hosts being adapted for communicating with a terminal connected to an Internet Protocol, IP, communication network, the first and the second host being connectable to the IP communication network by means of a switch, wherein each host is connectable to the switch by means of an individual link, wherein one of the hosts is operating as active host and the other host is operating as backup host, the first host comprising:
a detecting unit adapted to detect a link failure between the active host and the switch, or a malfunction of the active host;
a determining unit adapted to determine a backup host to take over from the active host; and
an associating unit adapted to associate the IP address and the MAC address of the active host to the determined backup host to take over.

27. The first host according to claim 26, wherein the first host is the backup host.

28. The first host according to claim 26, wherein the detecting unit is adapted to detect the link failure between the active host and the switch, or the malfunction of the active host by detecting an absence of status information messages.

29. The first host according to claim 28, further comprising a timing unit adapted to start a timer of a predetermined length upon reception of a status information message from the active host, wherein if the timer expires before a subsequent status information message is received, then the detecting unit is adapted to detect the link failure between the active host and the switch, or the malfunction of the active host.

30. The first host according to claim 26, wherein the detecting unit is adapted to detect the link failure between the active host and the switch, or the malfunction of the active host by receiving a notification message from the active host or from a control unit.

31. The first host according to claim 30, wherein the notification message from the active host or from the control unit comprises the IP address and the MAC address of the active host.

32. The first host according to claim 26, wherein the first host further comprises a memory having the IP address and the MAC address of the active host stored therein.

33. A first host according to claim 26, wherein the first host further comprises a triggering unit adapted to trigger a MAC learning process in the switch.

34. The first host according to claim 26, wherein the first host is the active host.

35. The first host according to claim 35, wherein the first host comprises a status unit adapted to send status messages to the backup host.

36. The first host according to claim 35, wherein the status unit further is adapted to send a poll message towards the switch, wherein the detecting unit adapted to detect a link failure between the active host and the switch if no response to the poll message is received via the switch.

37. The first host according to claim 35, further comprising a sending unit adapted to send a notification message to a control unit or to the backup host, the notification message informing the control unit or the backup host about the link failure between the active host and the switch.

38. The first host according to claim 37, wherein the notification message further comprises the IP address and the MAC address of the active host.

39.-42. (canceled)

43. A non-transitory computer-readable medium having instructions stored thereon that when executed by a processor cause the host arrangement to perform the steps of method claim 1.

44. A non-transitory computer-readable medium having instructions stored thereon that when executed by a processor cause the first host to perform the steps of method claim 10.
